(19) United States
(12) Patent Application Publication
(10) Pub. No.: US 2026/0304223 A1
(43) Pub. Date: Oct. 1, 2026

(54) TECHNOLOGIES FOR USER PLANE OPERATION OF MULTI-HOP COMMUNICATIONS

(71) Applicant: Apple Inc., Cupertino, CA (US)

(72) Inventors: Zhibin Wu, Los Altos, CA (US); Naveen Kumar R. Palle Venkata, San Diego, CA (US); Yuqin Chen, Beijing (CN); Peng Cheng, Beijing (CN); Ping-Heng Kuo, London (GB); Ralf Rossbach, Munich (DE); Fangli Xu, Beijing (CN); Alexander Sirotkin, Tel Aviv (IL); Haijing Hu, Los Gatos, CA (US)

(73) Assignee: Apple Inc., Cupertino, CA (US)

(21) Appl. No.: 19/462,937

(22) Filed: Jan. 28, 2026

Related U.S. Application Data
(60) Provisional application No. 63/779,968, filed on Mar. 28, 2025.

(51) Int. Cl. H04W 28/06; H04W 28/04; H04W 88/04

(52) U.S. Cl. CPC H04W 28/06; H04W 28/04; H04W 88/04

(57) ABSTRACT

The present application relates to devices and components including apparatus, systems, and methods for user plane operation of multi-hop communications within such networks.

### CROSS-REFERENCE TO OTHER APPLICATION

This application claims priority to U.S. Provisional Patent Application No. 63/779,968, for “TECHNOLOGIES FOR USER PLANE OPERATION OF MULTI-HOP COMMUNICATIONS” filed on Mar. 28, 2025, which is herein incorporated by reference in its entirety for all purposes.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates aspects of a user equipment in further detail in accordance with some embodiments.

FIG. 3 illustrates a timing diagram in accordance with some embodiments.

FIG. 4 illustrates a control signaling header in accordance with some embodiments.

FIG. 5 illustrates a signaling diagram in accordance with some embodiments.

FIG. 6 illustrates another signaling diagram in accordance with some embodiments.

FIG. 7 illustrates another signaling diagram in accordance with some embodiments.

FIG. 8 illustrates another signaling diagram in accordance with some embodiments.

FIG. 9 illustrates an operation flow or algorithmic structure in accordance with some embodiments.

FIG. 10 illustrates another operation flow or algorithmic structure in accordance with some embodiments.

FIG. 11 illustrates another operation flow or algorithmic structure in accordance with some embodiments.

FIG. 12 illustrates a user equipment in accordance with some embodiments.

FIG. 13 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

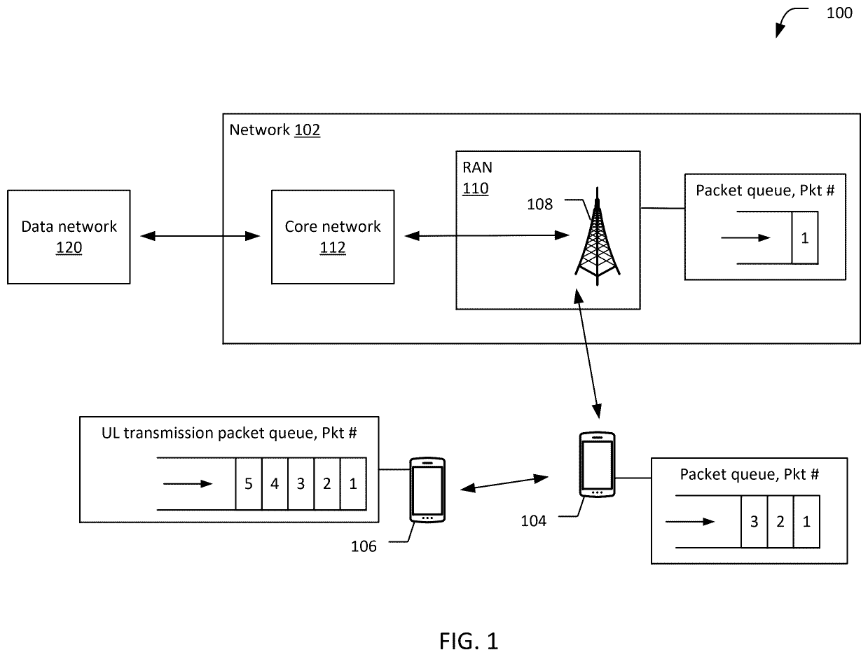

FIG. 1 illustrates a network environment 100 in accordance with some embodiments. The network environment 100 may include a UE 104 communicatively coupled with a base station 108 of a radio access network (RAN) 110. The UE 104 and the base station 108 may communicate over air interfaces compatible with 3GPP TSs, such as those that define a Fifth Generation (5G) new radio (NR) system, a Sixth Generation (6G) system, or a later system. The base station (BS) 108 may provide user plane and control plane protocol terminations toward the UE 104. The network environment may include remote UEs, e.g., UE 106. The remote UE 106 may not have a direct communication link with the BS 108 but may be communicatively coupled with network 102 through the UE 104. UE 104, when acting as a relay to carry data (including user plane or control plane), traffic of the remote UE 106 may be referred to as relay UE 104.

Operations described herein as associated with devices of the network environment 100 (for example, the UE 104, the UE 106, and the base station 108) may be fully, substantially, or partially performed by the processor circuitry of the device.

The network environment 100 may further include a core network 112. For example, the core network 112 may comprise a 5G Core network (5GC), a 6G core network (6GC), or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions. The core network 112, RAN 110, and RAN 110 may collectively be referred to as network 102.

The network environment 100 may further include a data network 120. Data network 120 may include a system of interconnected nodes that facilitate data transmission between UE 104 and various application servers and other service providers. The base station 108 and the core network 112 may route application data between the UE 104 and external data network 120 or application servers. These application servers may host web applications, cloud storage, and multimedia streaming services, which communicate with the UE 104 via standardized protocols and interfaces defined by 3GPP, ensuring secure and efficient data exchange.

The remote UE 106, which may be an extended reality (XR) device such as augmented reality glasses, can benefit from tethering with the relay UE 104. This tethering may provide advantages such as computing off-load, improving throughput and reliability, extending coverage, and reducing power consumption. The relay UE 104 may act as an intermediary, facilitating communication between the remote UE 106 and the base station 108 by leveraging either 3GPP or non-3GPP protocols. Communication between these devices may involve direct links, such as Sidelink for 3GPP or WiFi Direct for non-3GPP, enhancing connectivity and reducing latency.

The interaction between the remote UE 106, relay UE 104, and base station (BS) 108 involves distinct protocol stacks tailored to their roles in the communication process. In 3GPP-based communication, the remote UE 106 may employ layers such as the Service Data Adaptation Protocol (SDAP), Packet Data Convergence Protocol (PDCP), and Sidelink Relay Adaptation Protocol (SRAP) for communication over both the Uu interface (connecting to the base station) and the Sidelink (direct communication with the relay UE 104). These layers may facilitate secure and efficient data transmission by mapping Quality of Service (QoS) flows, compressing headers, encrypting data, and managing sidelink communication. In contrast, the relay UE 104 may operate primarily on SRAP, Radio Link Control (RLC), Medium Access Control (MAC), and Physical (PHY) layers for Sidelink communication with UE 106 and Uu interface communication with BS 108. Notably, the relay UE 104 may lack the SDAP and PDCP protocol layers, meaning it cannot access or interpret information specific to those layers, such as Packet Data Unit (PDU) set identifiers (IDs) or sequence number details. The BS 108 may utilize SDAP, PDCP, SRAP, RLC, MAC, and PHY layers to communicate with the remote UE 106 over the Uu interface, providing QoS prioritization and reliable data transfer.

The absence of SDAP and PDCP layers at the relay UE 104 may introduce a limitation in multi-hop communication. While the remote UE 106 and BS 108 exchange information at SDAP and PDCP layers, this exchange occurs transparently through the relay UE 104, which acts as an intermediary without visibility into the packets (PDUs or service data units (SDUs)) or the associated metadata. This lack of awareness may create challenges in managing PDU sets.

For example, SDAP and PDCP layers may categorize packets into PDU sets, where the loss of one packet within a set can prompt the transmitter to discard the entire set. However, because the relay UE 104 cannot associate packets with their respective PDU sets, it may continue forwarding packets from a partially delivered PDU set even if one packet in the set is dropped. Furthermore, the relay UE 104 cannot notify the upstream node, such as the remote UE 106, to stop transmitting packets from a failed PDU set. This disconnect disrupts efficient resource management and can lead to unnecessary transmissions, wasted resources, and reduced performance in scenarios requiring strict QoS compliance.

In one example, the relay UE 104 may not have access to upper-layer information, such as the PDU set parameters carried by the PDCP layer. This limitation may mean that the relay UE 104 operates at the RLC layer, which lacks visibility into the higher-layer information required to manage PDU sets. As a result, the relay UE 104 may not be able to make informed decisions about whether to continue relaying packets when a previous hop fails to deliver part of a PDU set in time.

In one example, the remote UE 104 successfully sends PDUs #1, 2, and 3 to the relay UE 104. Moreover, the relay UE 104 successfully sends the PDU #1 to the BS 108. If PDU #4 fails to meet the delay budget during the first hop, e.g., the remote UE 106 fails to send PDU #4 to the relay UE 104 on time, while PDUs #1, #2, and #3 are successfully delivered to the relay UE 104, the relay UE 104 must drop the undelivered packets PDU #2 and 3 to conserve radio resources in the next hop. This issue can manifest in both uplink and downlink scenarios. In the downlink, the BS 108 may need to notify the relay UE 104 that a PDU set has failed via signaling, prompting the relay UE 104 to discard any undelivered packets.

To remove ambiguity with directional terminology, the transmitting entity—such as the remote UE 106 in uplink (UL) transmission or the BS 108 in downlink (DL) transmission—is referred to as the upstream node, while the receiving entity—such as the BS 108 in UL transmission or the remote UE 106 in DL transmission—is designated as the downstream node.

In another scenario, next-hop delivery failures can adversely affect the upstream node. For example, suppose the relay UE 104 fails to deliver part of a PDU set to the downstream node (e.g., the BS 108 in UL transmission). In that case, the upstream node (e.g., the remote UE 106 in UL transmission) should cease transmitting packets from that PDU set to avoid unnecessary resource consumption. Such coordination between upstream and downstream nodes is paramount; however, the relay UE 104's inability to recognize PDU set groupings complicates this process, leading to potential inefficiencies. For instance, if PDU #2 fails during the second hop (e.g., from the relay node 104 to the downstream node), the upstream node (e.g., the remote UE 106 in the UL transmission) should drop the remaining packets in that PDU set to avoid wasting resources. This coordination between upstream and downstream nodes is critical in multi-hop scenarios, but the lack of PDU set awareness at the relay UE 104 complicates the process. The relay UE 104 cannot identify or prioritize PDU sets due to its agnosticism to PDCP-layer information.

Addressing these challenges requires introducing PDU set awareness at the relay UE 104 and implementing mechanisms to discard incomplete PDU sets. In one embodiment, a new “shim” layer is inserted below the PDCP layer to encapsulate end-to-end information. This shim layer may carry a PDU set identifier (ID) or other fields, such as a sequence number, thereby enabling the relay UE 104 to recognize packets belonging to the same PDU set and make more informed forwarding decisions.

In some embodiments, various signaling protocols and control schemes are introduced to mitigate the issues of partial PDU set delivery. For instance, dedicated control PDUs may be transmitted to signal that a PDU set has failed, and timer-triggered mechanisms can be configured such that if the delay budget for a PDU set is exceeded, any remaining packets are dropped. Additionally, or alternatively, event-triggered strategies that monitor transmission failures can prompt the relay UE 104 to discontinue forwarding packets once a predefined failure threshold is reached.

Furthermore, preemptive Delay Status Reporting (DSR) is introduced to compensate for the relay UE 104's lack of PDCP-layer information. By leveraging predictive information provided by the remote UE 106—such as current buffer occupancy and an estimate of the remaining delay budget—the relay UE 104 can proactively report delay-critical conditions to the BS 108, thereby requesting uplink resource allocations for time-sensitive data. In some implementations, this may involve extending the standard DSR message format with additional flags or fields (e.g., a “preemptive DSR” indicator) to capture the number of hops in the communication chain and to report on buffer size and delay constraints, ensuring timely and efficient resource management.

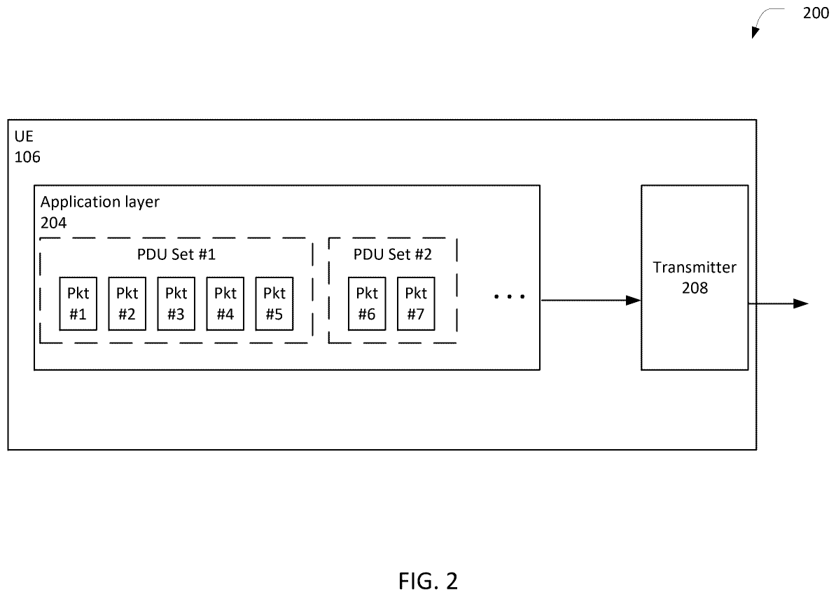

FIG. 2 illustrates aspects of the UE 104 or 106 in further detail in accordance with some embodiments. The UE 104 or 106 may include an application layer 204 that generates application traffic to be transmitted to another device through the network environment 100. In some embodiments, the application layer 204 may have an XR application that generates XR traffic. However, embodiments are not limited to XR use cases.

For XR and other services, the application layer 204 may generate PDU sets, with individual PDU sets comprising one or more packets. A packet, also referred to as a PDU, may be an Internet protocol (IP) packet or a non-IP packet. As shown, PDU set #1 may include packets #1-#5, while PDU set #2 includes packets #6 and #7. Each PDU set may be mapped to a different QoS flow. Different PDU sets may be mapped to different traffic flows when they correspond to different traffic flows or modalities.

The packets of a PDU set may carry a payload of one unit of information generated by the application layer. The unit of information may be a frame or video slice for XR Services, such as those defined in 3GPP Technical Report (TR) 26.926 v18.1.0 (2024-01), for example. In some implementations, all PDUs in the PDU Set may be needed by an application layer at a destination node to allow the application layer to recover parts or all of the information unit. In other implementations, the application layer on the destination node may still be able to recover parts or all of the information unit, even if some PDUs of a PDU set are missing.

In some embodiments, the data produced by an application layer of the UE 104 or 106 may include multi-modal data. Multi-modal data may include input data from different devices/sensors or output data to different destinations (e.g., one or more UEs) desired for the same task or application. Multi-modal data may include more than one single-modal data (e.g., one type of data), and there may be a strong dependency among each single-modal data associated with multi-modal data.

In some embodiments, the data produced by an application layer may be in a data burst. A data burst may include, for example, data produced by the application layer in a short period of time. The data burst may include PDUs from one or more PDU Sets.

The PDU sets may be provided to a transmitter 208 of the UE 104 or 106. The transmitter 208 may be configured to execute a communication protocol stack to facilitate communication via the network environment 100. The transmitter 208 may implement L2 and L1 functionality. At the L2 level, transmitter 208 may include an SDAP layer, a PDCP layer, an RLC layer, and a MAC layer. At the L1 level, the transmitter 208 may include a physical (PHY) layer. Briefly, the SDAP layer may manage QoS flow handling between the QoS flows and the data radio bearers (DRBs). The PDCP layer may manage robust header (de)compression and security between DRBs and RLC channels. The RLC layer may manage (re-)segmentation and error correction through automatic repeat requests (ARQ) between logical channels and RLC channels. The MAC layer may manage scheduling/priority handling, (de)multiplexing, and hybrid automatic repeat request (HARQ) processes between logical channels and transport channels. The PHY layer may manage the processing of the physical data and control channels.

In some embodiments, various information may be provided by the core network 112 to the RAN 110 to assist in handling QoS flows and PDUs. This information may be consistent with that described in 3GPP TR 23.700-60 v18.0.0 (2022-12-21). This information may include semi-static information for both uplink and downlink, PDU set QoS parameters, and dynamic information for downlink.

The semi-static information for both uplink and downlink may be provided via the control plane (NGAP). This information may include periodicity for uplink and downlink traffic of the QoS Flow via time-sensitive communications assistance information (TSCAI)/time-sensitive communications assistance container (TSCAC) and traffic jitter information (e.g., jitter range) associated with each periodicity of the QoS flow.

The PDU set QoS parameters may include a PDU Set Error Rate (PSER) to define an upper bound for the rate of PDU Sets that have been processed by the sender of a link layer protocol but that are not successfully delivered by the corresponding receiver to the upper layer. See, for example, 3GPP TR 23.700-60. In some instances, a PDU set may be considered as successfully delivered when all PDUs of a PDU Set are delivered successfully. In other instances, other definitions of successful delivery may be made. In some instances, if one PDU of a PDU set is discarded, all remaining PDUs of the PDU set may be discarded.

The PDU set QoS parameters may further include a PDU Set Delay Budget (PSDB) that defines a time between the reception of a first PDU and the successful delivery of a last-arrived PDU of a PDU Set. See, for example, 3GPP TR 23.700-60. The PSDB may be an optional parameter in various embodiments.

The PDU set QoS parameters may further include a PDU Set importance (PSI) to indicate the relative importance of a PDU set compared to other PDU sets within the same QoS flow.

A PDU set may be associated with the following information: a PDU set sequence number (SN); a PDU set size (in bytes); a PDU SN within a PDU Set; an end PDU of the PDU Set indication; a PDU set importance (PSI); and an end of data burst indication in the header of a last PDU of the data burst. The PSI may be used to identify the importance of a PDU Set within a QoS flow. The RAN 110 may use the PSI for PSI-based discarding in the presence of congestion, as described herein.

The application, application server, application function, or application layer may assign a PSI level for each packet or PDU set or may define rules and policies for assigning a PSI level to a type of packet or PDU set. For example, the application may assign a PSI level to packets associated with audio data and a different PSI to packets or PDU sets associated with real-time video data. The application may assign different PSI to payloads associated with different video frame types within a video stream. PSI level selection may be influenced by factors such as type of application (e.g., video, audio, text), details of codec (e.g., H.264 or high-efficiency video coding, HEVC), level of error propagation when a PDU set is discarded, or inter-dependency among PDU sets (e.g., whether a PDU set is necessary for the processing of some other PDU sets). The PSI selection may be similar to that described in 3GPP TS 26.522 v 18.1.0 (2024-07-12).

PSI may have N levels, e.g., levels 0 to N-1. The higher PSI level values may be associated with less importance. Some of the PSI levels may indicate no interdependency with other PDU sets. For example, there may be 16 levels of PSIs, e.g., level 0 to level 15. PSI levels 14 and 15 may indicate no inter-dependency to other PDU sets; e.g., a PDU set having PSI level 14 may not have inter-dependency to other PDU sets. PDU sets with other PSI levels, e.g., levels 0 to 13, may be needed to process other PDU sets. These values may differ in other embodiments.

In some instances, the BS 108 may instruct the UE 104 or 106 to apply different discarding timers for PDU sets with different PSIs. For example, a PDU set with a large PSI level may have a shorter discard timer than a PDU set with a smaller PSI level. This mechanism may be called PSI-based discarding or importance-based discarding.

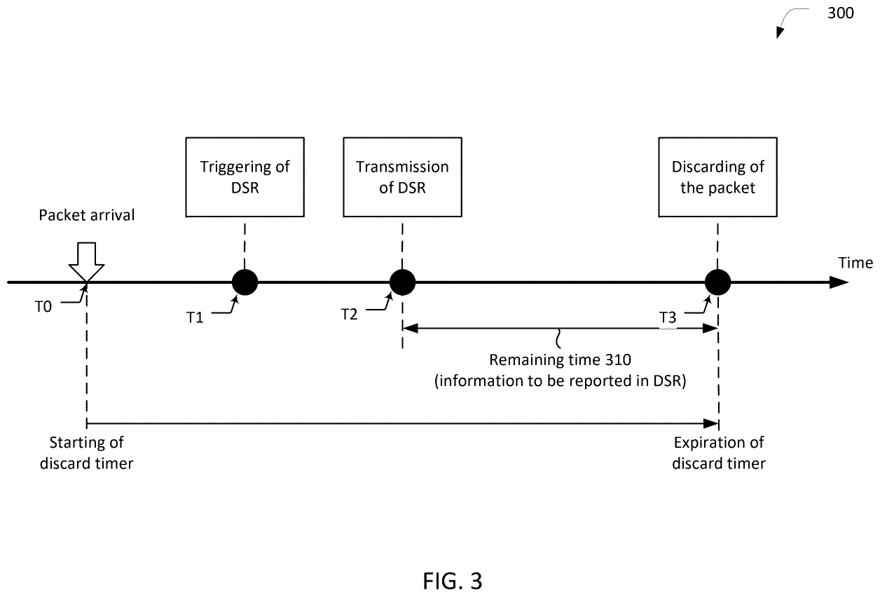

FIG. 3 illustrates a timing diagram 300 for generating and transmitting a delay status report (DSR) in accordance with some embodiments. The DSR may assist in delay-aware scheduling. A DSR may be triggered when the remaining time till the data is discarded is below a threshold.

At T0, a buffer of a transmitting entity (e.g., UE PDCP transmitting entity in uplink transmission or base station PDCP transmitting entity in downlink transmission) and associated with a logical channel (LCH) or a logical channel group (LCG) can receive a data packet for transmission. At T0, the transmitting entity can start a discard timer, in which it will discard the data if, by expiration of the timer, the transmitting entity has not successfully transmitted the data packet. At T1, a first time interval (e.g., T3-T1) is reached, where the time remaining prior to the expiration of the discard timer has reached a threshold, such that a DSR is triggered. At T2, a DSR report is generated and transmitted. The DSR can include data volume information. For example, the DSR may include the buffer size or a reported remaining time 310 when the DSR is transmitted. The reference point for measuring the reported remaining time 310 may be the transmission of DSR. UE may report the DSR in a MAC control element (CE).

As mentioned above, DSR may include buffer size. The UE may determine the buffer size through data volume calculation. 3GPP TS 38.323 v. 18.4.0 (2024-12) describes data volume calculation for delay status reporting.

3GPP TS 38.323 introduces delay-critical PDCP SDUs to calculate buffer size for the DSR. Similarly, 3GPP TS 38.322 v. 18.2.0 (2024-12) introduces delay-critical RLC SDUs to calculate buffer size for DSR.

The delay-critical PDCP SDU may be defined as a PDCP SDU for which the remaining time till discarding is less than a first threshold when PDU set discarding is not configured. When the PDU set discarding is configured, a PDCP SDU is delay-critical if it belongs to a PDU set in which at least one PDCP SDU has the remaining time till discarding less than a second threshold. Note that the remaining time till discarding is the actual remaining time of the discard timer, whereas the reported remaining time 310 is the remaining time on the discard timer at the time of generating or transmitting the DSR. Similarly, a delay-critical RLC SDU is defined as an RLC SDU corresponding to a PDCP PDU indicated as delay-critical by PDCP.

In some instances, for the purpose of MAC delay status reporting, the transmitting PDCP entity may consider the following as delay-critical PDCP data volume: 1) delay-critical PDCP SDUs for which no PDCP Data PDU have been constructed; 2) PDCP Data PDU that contain the delay-critical PDCP SDUs and have not been submitted to lower layers; 3) PDCP Control PDUs; 4) for AM DRBs, PDCP SDUs to be retransmitted; and 5) for AM DRBs, PDCP Data PDUs to be retransmitted.

In some instances, for the purpose of MAC buffer status reporting, the UE may consider the following as RLC data volume: 1) RLC SDUs and RLC SDU segments that have not yet been included in an RLC data PDU; 2) RLC data PDUs that are pending for initial transmission; and 3) RLC data PDUs that are pending for retransmission (RLC AM). Additionally, the UE may also consider the following as delay-critical RLC data volume: 1) delay-critical RLC SDUs and delay-critical RLC SDU segments that have not yet been included in an RLC Data PDU; 2) RLC Data PDUs pending for initial transmission and containing a delay-critical RLC SDU or a delay-critical RLC SDU segment; and 3) RLC Data PDUs that are pending for retransmission (RLC AM). In addition, if a status PDU has been triggered and a prohibition timer, t-StatusProhibit, is not running or has expired, the UE may estimate the size of the status PDU that will be transmitted in the next transmission opportunity and consider this as part of RLC data volume for MAC buffer status reporting and as part of delay-critical RLC data volume for MAC delay status reporting.

In some embodiments, an identifier associated with an RLC SDU may indicate whether it is delay-critical, e.g., a one-bit indicator. RLC PDUs may be considered delay-critical if they are associated with delay-critical RLC SDUs or delay-critical RLC SDU segments. RLC Data PDUs of both initial transmission or retransmission may be considered as delay-critical.

In some embodiments, an RLC SDU or SDU segment may be associated with a parameter associated with the discard timer or the PDCP SDU associated with the RLC SDU or SDU segment. The parameter may include a value of the remaining time till discarding, e.g., the remaining time till the discard timer expires.

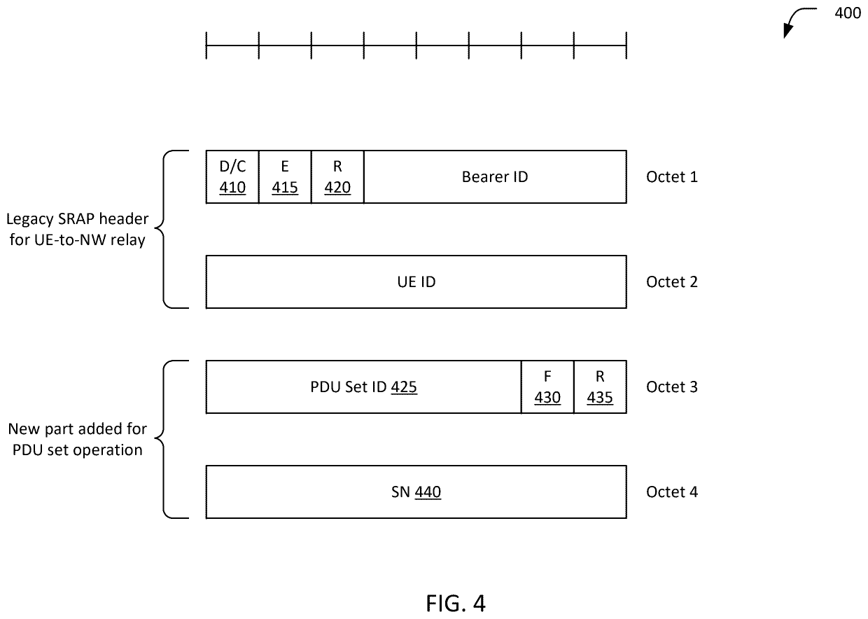

FIG. 4 illustrates a control signaling header 400 in accordance with some embodiments. The control signaling header 400 may be used to facilitate enhanced relay control between a UE (e.g., the UE 104 or 106) and the network 102 (e.g., the BS 108). As the PDU set is a concept defined at the PDCP layer and above—representing end-to-end information for a PDCP-level connection rather than being handled hop-by-hop—it may be beneficial to transport this information via a “shim” layer header, e.g., control signaling header 400, inserted underneath PDCP. The shim layer header 400 may carry the end-to-end user plane information through the lower-layer signaling, such as the SRAP layer, and makes the otherwise inaccessible PDCP parameters, notably the PDU set ID and sequence number details, available to the relay UE 104. Without the shim layer header 400, the relay UE 104, which operates at lower layers and does not have access to the SDAP/PDCP layers, would be unable to make informed decisions about packet forwarding or discarding when parts of a PDU set are lost or delayed.

In one embodiment, the control signaling header 400 is structured into four octets, with each octet comprising eight bits, thereby integrating both legacy and novel signaling functions. The first two octets conform to the legacy SRAP header design utilized for UE-to-network relay. Specifically, the first octet is segmented into three one-bit fields or flags 410, 415, and 420, followed by a 5-bit field designated as the “Bearer ID.” The second octet may carry the “UE ID,” which, in traditional designs, is an 8-bit local identifier that may be omitted in fixed 1-to-1 tethering relationships. One of the one-bit fields or flags, e.g., data/control (D/C) flag 410, may indicate whether the header or the associated message pertains to data transmission or control signaling, thereby distinguishing between packets carrying user data and those carrying control information necessary for managing transmission or relay operations. In some embodiments, flag 415 is specifically used to indicate whether the PDU set extension, e.g., the third and fourth added octets, is included.

In some embodiments, the header is further expanded by incorporating two octets specifically for PDU set operations. In this improved signaling scheme, the third octet may include a field 425 designated as the “PDU Set ID” that uniquely identifies the PDU set. In one example, the PDU Set ID field 425 may be a 6-bit field followed by two reserved one-bit fields 430 and 435 (each may be labeled as “R”), available for future control refinements or additional functionality. In some embodiments, the field 430 may be modified to indicate the “fail” status of the PDU set. The fourth octet may contain the “SN” (sequence number) field 440, which is used to allow for correct ordering and tracking of PDU packets as they traverse the relay link.

In some embodiments, control signaling header 400, augmented by the shim layer, may enable the relay UE 104 to determine whether packets belong to a common PDU set and to make informed decisions about forwarding or discarding packets based on their delivery status. This capability is particularly advantageous in multi-hop relay scenarios since conventional 3GPP implementations rely on PDCP layer information for PDU set management —information that would otherwise be hidden from the relay UE 14. The shim layer header 400 may provide this end-to-end PDCP information, thereby enabling efficient resource management and robust QoS even when relay operations occur solely at the lower layers.

The additional information carried in the header—such as the shim layer fields that transport end-to-end PDCP parameters (for example, the PDU set ID and sequence number details)—introduces extra overhead in the control signaling process. Although these fields provide the relay UE with access to management information normally confined to the SDAP/PDCP layers, they add extra bits to each transmitted packet. The following two options may be implemented to reduce the overhead.

In Option 1, the PDU set extension may be an optional feature. This approach is applicable in scenarios where the downstream node gains minimal benefit from the additional PDCP layer information—for instance, in the final hop of a multi-hop relay system. By omitting the PDU set extension when it is not required, the signaling overhead can be reduced without sacrificing necessary control functionality.

In Option 2, a PDCP control PDU may be employed to facilitate targeted signaling for discarding PDCP packets at the downstream node. In this approach, the downstream node may generate and transmit a request—forwarded via the relay UE—that asks the upstream node to identify specific PDCP packets associated with a particular PDU set ID for discarding. Rather than embedding full PDU set information in every user plane packet header, this control PDU may selectively convey instructions, reducing unnecessary overhead. Upon receipt of the control PDU, the upstream node may evaluate the request and determine the status of the PDCP packets corresponding to the PDU set identifier. The upstream node may compile a list of PDCP packets that meet the criteria for discarding, such as packets that have failed delivery or exceeded delay constraints, and may transmit this list to the downstream node. Subsequently, the downstream node may perform the discard operation based on the received list, freeing up resources for other transmissions. This approach may enhance signaling efficiency by focusing on selective discard-related operations rather than carrying redundant PDU set details in every packet header, which is particularly beneficial in relay scenarios where intermediate nodes lack access to upper-layer PDCP information. Relevant discussions in the transcription highlight that such coordinated signaling mechanisms are advantageous for conserving radio resources and avoiding retransmissions of packets that no longer contribute to QoS objectives due to failure or delay constraints.

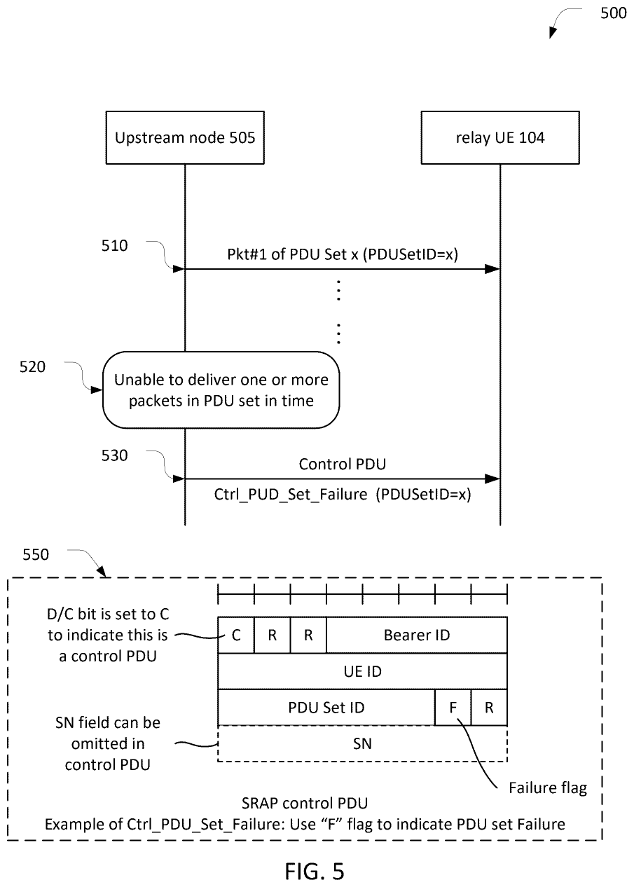

FIG. 5 illustrates a signaling diagram 500 in accordance with some embodiments. Signaling diagram 500 illustrates an example of using control signaling to inform the relay UE 104 of a failure associated with a PDU set. The signaling diagram 500 shows the signaling between upstream node 505 and the relay UE 104. The upstream node 505 may be the remote UE 106 in UL transmission or the BS 108 in DL transmission.

At 510, the upstream node 505 may generate and send a packet, e.g., packet #1 of PDU set ID=x, to the relay UE 104. The relay UE 104 may receive and process the packets and buffer them for forwarding to the downstream node. The upstream node 505 may continue the operation by sending other packets associated with the same PDU set, e.g., having the PDU set ID=x.

At 520, the upstream node 505 may determine that it is unable to deliver one or more packets of the PDU set (e.g., with PDU set ID=x) in time. The upstream node 505 can determine its inability to deliver one or more packets in a PDU set in time by monitoring feedback mechanisms, latency constraints, and channel conditions across various protocol layers. At the RLC or MAC layers, acknowledgment failures (via ACK/NACK signaling) and retransmission limits may provide direct indicators of delivery issues, as the node tracks retransmission attempts and buffer status. Discard timers at the PDCP layer may enforce latency requirements, prompting the node to drop packets if the remaining time before timer expiry is insufficient for successful delivery. Channel state information (CSI) and link quality metrics, such as signal-to-noise ratio and interference levels, may further help predict delivery success based on current conditions. Additionally, network policies and QoS configurations may establish latency thresholds that the node evaluates against its transmission capabilities. In 3GPP systems, tools like RLC Status Reports and PDCP discard timers enable precise tracking and timely decisions to drop packets that cannot meet delay budgets, ensuring efficient resource management.

At 530, in response to or based on the determination that it is unable to deliver one or more packets of the PDU set, the upstream node 505 may generate and transmit control PDU 550 to the relay UE 104. The control PDU may explicitly notify the relay UE 104 to discard the PDU set identified by the control PDU 550.

The control PDU 550 may include a D/C flag (e.g., flag 410 in FIG. 4) set to indicate that the control PDU 550 is a control PDU. The failure flag (e.g., flag 430 in FIG. 4) may indicate PDU set failure. In some embodiments, the SN field (e.g., SN field 440 in FIG. 4) may be omitted.

In some embodiments, the control PDU 550 is a dedicated control PDU. In some embodiments, the control PDU 550 may indicate other events or aspects of the PDU set, e.g., whether the importance or priority of the PDU set is changed.

In some embodiments, the operation described above can be used in the reverse direction as an intermediate node, e.g., the relay UE 104 may send the control PDU 550 to the upstream node 505 to inform that the PDU set has failed in a specific hop.

In some embodiments, the control PDU 550 may be an SL MAC CE, a Uu MAC CE, or a PDCP control PDU.

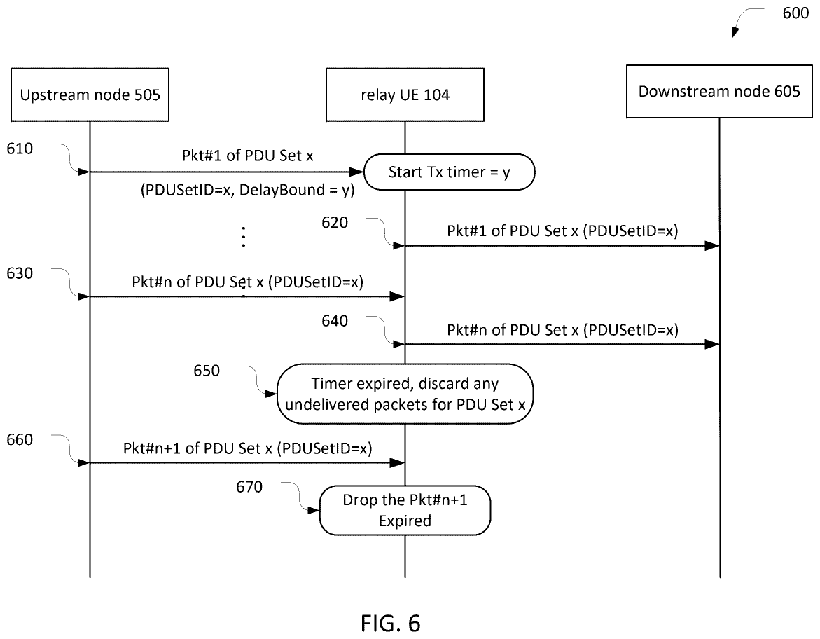

FIG. 6 illustrates another signaling diagram 600 in accordance with some embodiments. Signaling diagram 600 illustrates an example of using timers to enable the relay UE 104 to discard packets based on latency or transmission constraints. The signaling diagram 600 shows the signaling between upstream node 505, the relay UE 104, and the downstream node 605. The upstream node 505 may be the remote UE 106 in UL transmission or the BS 108 in DL transmission. The downstream node 605 may be the remote UE 106 in DL transmission or the BS 108 in UL transmission.

Managing PDU sets in multi-hop relay scenarios may involve mechanisms that allow intermediate nodes, e.g., the relay UE 106, to discard packets based on latency or transmission constraints, improving resource utilization and reducing unnecessary retransmissions. In some embodiments, the discard operation may be governed by timer-triggered mechanisms. These mechanisms may rely on delay-bound timers to track whether PDU sets can be delivered within required latency constraints. If a timer expires before the intermediate node delivers or receives all packets within a PDU set, the node discards the remaining packets in its buffer.

Two types of timers may be employed: the PDU set transmission timer, e.g., the PDUSet Tx Timer, and the PDU set receiving timer, e.g., the PDUSet Rx Timer. The PDUSet Tx Timer may be configured to monitor the delivery of packets to downstream nodes (e.g., downstream node or the intermediate nodes in the subsequent hops), discarding remaining packets if the intermediate node cannot deliver them within the specified delay-bound. The PDUSet Rx Timer functions similarly but monitors packets received from upstream nodes (e.g., upstream or source node and the nodes at previous hops), triggering discard operations if the node fails to receive all packets within the delay-bound. These timers may be configured based on latency requirements, which may be conveyed through user plane control PDUs or piggybacked within data PDUs. This approach may enable the intermediate nodes (e.g., the relay UE 104) to manage discard operations dynamically based on latency budgets that reflect the end-to-end QoS flow.

Additional signaling may be introduced to provide the intermediate nodes (e.g., the relay UE 104) with the necessary information for timer configurations. For instance, a delay-bound parameter can be included in the control PDU or data PDU, allowing the intermediate node (e.g., the relay UE 104) to associate the timer with a specific PDU set. This parameter may not need to be repeated for every packet; instead, it can be conveyed once when the PDU set is initiated, with subsequent packets inheriting the delay-bound configuration. The design may also accommodate scenarios where the timer allows undelivered packets in the current buffer to be processed while halting new packets, offering flexibility in managing traffic flows.

The intermediate node (e.g., the relay UE 104) may also determine the completeness of a PDU set to apply the discarding operations. One option involves associating a 1-bit end-marker with the last packet in the PDU set, signaling to the node that the set is complete. However, this approach assumes sequential delivery of packets, which may not always be feasible in multi-modal traffic scenarios or under conditions where upper layers do not clearly indicate the end of a PDU set. Another option introduces a numerical value representing the total number of distinctive packets in the PDU set, allowing the intermediate node (e.g., the relay UE 104) to track and verify the completeness of the set. Both methods offer ways to identify whether a PDU set has been fully delivered, enabling accurate discard operations when necessary.

In some embodiments, the delay-bound and completeness information may be delivered in a dedicated control PDU. For example, the control PDU may include fields for the PDU set ID, delay budget, and end-marker or packet count, enabling intermediate nodes (e.g., the relay UE 104) to make informed decisions about discard operations. Additionally, or alternatively, the control PDU may specify whether the delay-bound is applicable for Tx or Rx operations, further enhancing its utility in managing multi-hop relay traffic. These configurations may be performed via MAC CEs or PDCP headers, e.g., using one or more reserved fields of control headers of FIG. 4.

The intermediate nodes (e.g., the relay UE 104) can dynamically manage the PDU set packets by implementing timer-triggered discard mechanisms. Managing PDU sets dynamically based on latency constraints may allow the intermediate nodes (e.g., the relay UE 104) to discard delayed or failed packets, prioritize other traffic flows, or maintain efficient resource allocation.

The signaling diagram 600 is an example of the signaling and operation of the timers described above.

At 610, the upstream node 505 may generate and transmit a packet, e.g., Pkt #1, of a specific PDU set, e.g., PDU set ID=x. The relay UE 104 may be configured with a delay bound, e.g., DelayBound=y seconds(s), for packets associated with this PDU set. Upon receiving or processing the packet, e.g., Pkt #1, the relay UE 104 may start a timer to monitor the queuing delay or buffering time of the packets associated with this PDU set, e.g., PDU set ID=x.

At 620, the relay UE 104 may forward the received packet, e.g., Pkt #1, to the downstream node 605. In some examples, the downstream node 605 may be the destination node or another intermediate node, e.g., next hop, in a multi-hop transmission.

The upstream node 505 may continue transmitting packets of the PDU set with PDU set ID=x, and the relay UE 104 may continue forwarding those packets to the downstream node 605. For example, at 630, the upstream node 505 may generate and send Pkt #n of the PDU set with PDU set ID=x to relay UE 104. Subsequently, at 640, the relay UE 104 may forward Pkt #n of the PDU set with PDU set ID =x to the downstream node 605.

At 650, the relay UE 104 may detect or determine that the timer is expired and accordingly may discard any undelivered packets for PDU set with PDU set ID=x.

At 660, upstream node 505 may send Pkt #n+1 of the PDU set with PDU set ID=x to the relay UE 104. The relay UE 104, at 670, may drop the Pkt #n+1 based on the determination that the timer associated with the PDU set has expired.

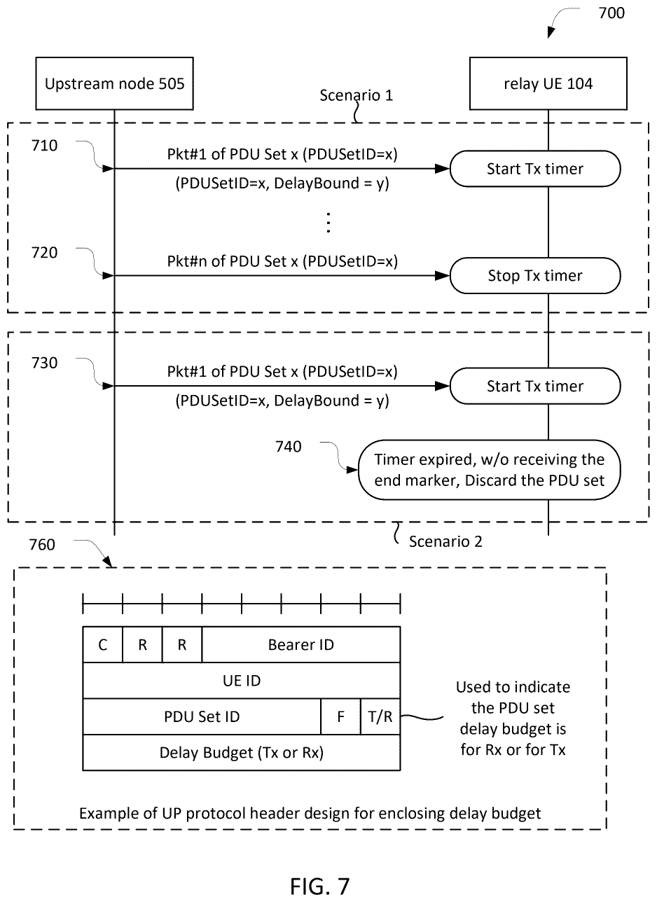

FIG. 7 illustrates another signaling diagram 700 in accordance with some embodiments. Signaling diagram 700 illustrates an example of using timers and end-markers or packet counts to enable relay UE 104 to discard packets based on latency or transmission constraints. The signaling diagram 700 shows the signaling between upstream node 505 and the relay UE 104. The upstream node 505 may be the remote UE 106 in UL transmission or the BS 108 in DL transmission.

An intermediate node, e.g., the relay UE 104, may not be able to determine the completeness of a PDU set, thereby complicating discard operations. For example, packet delivery from an upstream node 550 may occur out of sequence, causing the relay UE 104 to misinterpret whether the PDU set has been fully delivered, as noted in cases where an end-marker PDU is received prematurely or inaccurately, leading to a “false alarm.” Additionally, the upstream node 505 may fail to provide the total number of packets within a PDU set, leaving the intermediate node, e.g., the relay UE 104, unable to track completeness effectively, particularly when packets are missing or delayed in prior hops. Further complications may arise when transmission failures accumulate during the relay process, as intermediate nodes, e.g., the relay UE 104, lack visibility into prior retransmissions or failed packet delivery attempts, making it difficult to determine whether a PDU set can still be completed in time. To address this, several mechanisms may be employed to identify PDU set completeness and enable informed discard decisions when necessary.

One approach may involve the use of a 1-bit end-marker associated with the last packet in a PDU set. This marker may signal to the intermediate node, e.g., the relay UE 104, that the PDU set is complete, allowing the node to finalize its processing of the PDU set. For example, when the upstream node 505 delivers packets sequentially, the intermediate node, e.g., the relay UE 104, can start a timer upon receiving the initial packet of the PDU set. The timer continues until the end-marker is received, at which point the PDU set is considered complete, and the timer is stopped. However, this method assumes sequential delivery of packets and clear indications of the end of the PDU set, which may not always be feasible in scenarios involving multi-modal traffic or when upper layers do not explicitly define the boundaries of a PDU set. If the timer expires without the intermediate node receiving the end-marker, the node may discard the PDU set, e.g., the undelivered packets associated with the PDU set, due to incomplete delivery. This scenario is further complicated by transmission failures, where repeated NACK feedback or missing sequence numbers prevent the intermediate node from confidently determining whether the remaining packets in the PDU set can be delivered successfully.

Another method to determine completeness may involve introducing a numerical value that represents the total number of distinctive packets within a PDU set. This information can be delivered along with any packet in the PDU set, allowing the intermediate node, e.g., the relay UE 104, to track the number of packets it has processed relative to the total. For instance, upon receiving the first packet of a PDU set, the intermediate node, e.g., the relay UE 104, may start a timer and count subsequent packets until the specified total number is reached. If the count matches the expected number of packets, the node concludes that the PDU set is complete and stops the timer. However, if the timer expires before the intermediate node, e.g., the relay UE 104, receives all packets, or if the received count falls short of the expected total, the PDU set may be discarded. In this method, it is assumed that the upstream node 505 knows the total number of packets beforehand and may include the total number in the allocated field, e.g., a dedicated field or reusing the field for the sequence number, in the protocol header.

In some embodiments, transmission failure thresholds may be configured, where the intermediate node tracks failed delivery attempts using lower-layer feedback, such as RLC status reports or ACK/NACK signaling. If the number of failures exceeds the threshold, the intermediate node may discard the PDU set without waiting for completeness information, optimizing resource usage and reducing delays.

To support these mechanisms, delay-bound and completeness information may be delivered in a control PDU 760. The control PDU 760 may include fields such as the PDU set ID, the delay budget, the end-marker, or the total packet count, enabling intermediate nodes, e.g., the relay UE 104, to associate timers and discard operations with specific PDU sets. The delay budget may indicate whether the bound applies to transmission (Tx) or reception (Rx) operations, providing flexibility in managing traffic flows. For example, an intermediate node may start a timer based on the delay budget for Tx operations, discarding undelivered packets if the timer expires, or use the delay budget for Rx operations to discard unreceived packets after the timer expires. Additionally or alternatively, the delay budget information may not need to be included with every packet but can be conveyed once during the initiation of the PDU set, with subsequent packets inheriting the configuration. In cases where transmission failures are used as a criterion for discard operations, the control PDU may specify thresholds for failed delivery attempts, allowing intermediate nodes to terminate the processing of PDU sets that exceed these thresholds. This proactive approach prevents incomplete or delayed sets from propagating further through the relay chain.

By employing mechanisms such as end-markers or numerical packet counts, intermediate nodes can manage the completeness of PDU sets and apply discard operations based on latency constraints or transmission failures. These methods may reduce unnecessary retransmissions, prioritize resource allocation for other traffic flows, or prevent incomplete PDU sets from being propagated through the intermediate nodes, e.g., the relay UE 104.

The signaling diagram 700 is an example of the signaling and operation of the timer and end-marker or packet count described above.

In Scenario 1, at 710, the upstream node 505 may generate or send a packet, e.g., Pkt #1 of PDU set x, to relay UE 104. In the same transmission or by a control PDU, the relay UE 104 may be configured with the delay bound, e.g., DelayBound=y (s), associated with the PDU set. The relay UE 104 may start a timer when the packet is received or processed by the UE 104.

The upstream node 505 continues generating or transmitting the packets associated with the PDU set. At 720, the upstream node 505 generates the PDU set's nth packet, Pkt #n, and indicates the end-marker to the relay UE 104. The relay UE 104 receives the packet before the expiration of the timer and stops the timer based on the end-marker indicated by the upstream node 505.

In scenario 2, at 730, similar signaling and operations are performed at upstream node 505 and relay UE 104 as described above at 710.

At 740, the relay UE 104 may determine that the timer is expired without receiving the end-marker or the count of the received packets of the PDU set is less than the total number of packets in the PDU set, and the relay UE 104 discards the undelivered packets of the PDU set. In some instances, the relay UE 104 may discard any packets associated with the PDU set that are received after the expiration of the timer.

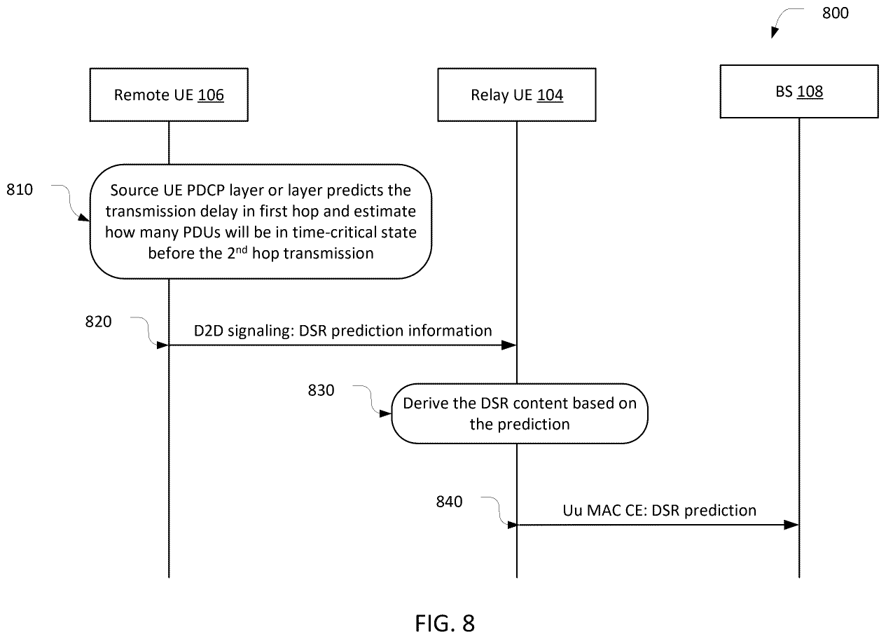

FIG. 8 illustrates another signaling diagram 800 in accordance with some embodiments. Signaling diagram 800 illustrates an example of using preemptive DSR. The signaling diagram 800 shows the signaling between remote UE 106 (e.g., upstream node 505), the relay UE 104, and the BS 108 (e.g., downstream node 605).

In some embodiments, a proactive mechanism may be employed to address challenges in scheduling uplink transmissions for the PDU sets where intermediate nodes (e.g., the relay UE 104) lack direct access to upper-layer PDCP information. This mechanism, referred to as preemptive DSR, may enable the intermediate nodes, e.g., the relay UE 104, to solicit uplink resources for delay-critical traffic before buffer overflow or discard timer expiration occurs. By predicting the delay status of packets, preemptive DSR may be used for timely scheduling and resource allocation for delay-sensitive flows.

Preemptive DSR may build on the principles of delay status reporting introduced in Rel-18, where UEs report the remaining time until PDCP discard timer expiry and buffer sizes for delay-critical traffic described above, e.g., in FIG. 3. In multi-hop relay scenarios, intermediate nodes such as the relay UE 104, may generate preemptive DSR messages to downstream nodes (e.g., the BS 108 in the UL transmission) based on predicted delay budgets for packets in transit. For instance, the relay UE 104 may estimate the remaining time for packets originating from the remote UE 106 by accounting for delays incurred in prior hops. This prediction may be derived from information provided by the remote UE 106, including buffer sizes and remaining time values for delay-critical packets. The number of hops between the remote UE and the relay UE 104 or the Bs 108 may also be considered to refine these predictions further.

The format of preemptive DSR messages may resemble conventional DSR MAC CEs and may include additional fields to support multi-hop relay use cases. For example, preemptive DSR messages may include a flag indicating their proactive nature, distinguishing them from standard DSR reports. The message may also contain the number of hops between the remote UE 106 (or the upstream node 505) and the relay UE 104 or the BS 108 (or the downstream node 605), enabling downstream nodes to adjust their scheduling strategies based on topology-specific latency constraints. Buffer size and remaining time information for delay-critical packets are associated with logical channels, while the number of hops is treated as a separate field, allowing for independent processing by downstream nodes.

In some embodiments, preemptive DSR messages may be triggered when intermediate nodes, e.g., the relay UE 104, predict that delay-critical packets may exceed latency budgets before reaching their destination. For instance, when the relay UE 104 detects that packets in its buffer are approaching PDCP discard timer limits, the relay UE 104 may generate a preemptive DSR message to request uplink resources from the BS 108. This proactive signaling may allow the delay-critical traffic to be prioritized for transmission, reducing the likelihood of packet loss due to timer expiry. The relay UE 104 may derive its predictions using information received from the remote UE 106, such as the initial delay budget and transmission delay incurred in prior hops.

The preemptive DSR can be implemented using enhanced MAC signaling formats. For example, Rel-18 DSR mechanisms include configurations for reporting delay status, buffer sizes, and discard timer thresholds. Preemptive DSR extends these capabilities by introducing prediction-based reporting, allowing relay nodes to anticipate and address latency issues before they impact packet delivery. Logical Channel Identifiers (LCIDs) or enhanced LCIDs (eLCIDs) may be used to distinguish preemptive DSR from conventional DSR messages for integration with existing protocol designs.

The signaling diagram 800 is an example of the operation of preemptive DSR described above.

At 810, the remote UE 106 may predict the transmission delay in the first hop and may estimate how many PDUs will be in a time-critical state before the 2^{nd} hop transmission. The information to generate the DSR may include buffer size for packets with a certain range of remaining time, the delay bound, which may be an estimate of the remaining delay budget once the packet reaches the next hop or the current remaining time from the remote UE 106 perspective.

At 820, the remote UE 106 may use D2D signaling to send a DSR prediction to relay UE 104. This operation may enable the remote UE 106 to communicate anticipated delay status information for its delay-critical packets to the relay UE 104 via direct D2D communication. The DSR prediction may include details such as buffer size, remaining time until PDCP discard timer expiry, and estimated delay budgets for packets in transit. By providing this information, the remote UE 16 may help the relay UE 104 assess the urgency of the packets and prioritize them accordingly. Additionally, the DSR prediction may account for the number of hops between the remote UE and the relay UE, enabling a more accurate estimation of potential latency. This D2D signaling ensures that the relay UE has sufficient context to manage delay-critical traffic effectively, even in scenarios where direct access to upper-layer information is unavailable.

At 830, the relay UE 104 may derive the DSR content based on the prediction. Upon receiving the DSR prediction from the remote UE 106, the relay UE 104 may process the information to generate a preemptive DSR message tailored to its current network topology and resource availability. The relay UE 104 may calculate the remaining delay budget for the packets, incorporating the latency incurred during previous hops and accounting for the predicted buffer sizes, and discard timer constraints provided by the remote UE 106. The derived DSR content my include logical channel-specific buffer size and remaining time data, as well as additional fields, such as the number of hops, to ensure downstream nodes can make informed scheduling decisions. This operation may allow the relay UE 104 to proactively address latency issues and prepare for uplink resource requests for the timely transmission of delay-sensitive packets.

At 840, the relay UE 104 may forward DSR prediction to the BS 108, e.g., using a Uu MAC CE. Once the relay UE 104 derives the DSR content, it may send the preemptive DSR message to the BS 108 via Uu interface MAC CE. This uplink signaling may convey information about delay-critical traffic originating from the remote UE 106, including buffer size, remaining time until discard timer expiry, and the number of hops that packets have traversed. The BS 108 may use the DSR prediction to prioritize uplink resource allocation for the delay-sensitive packets, enabling timely scheduling and reducing the likelihood of packet loss.

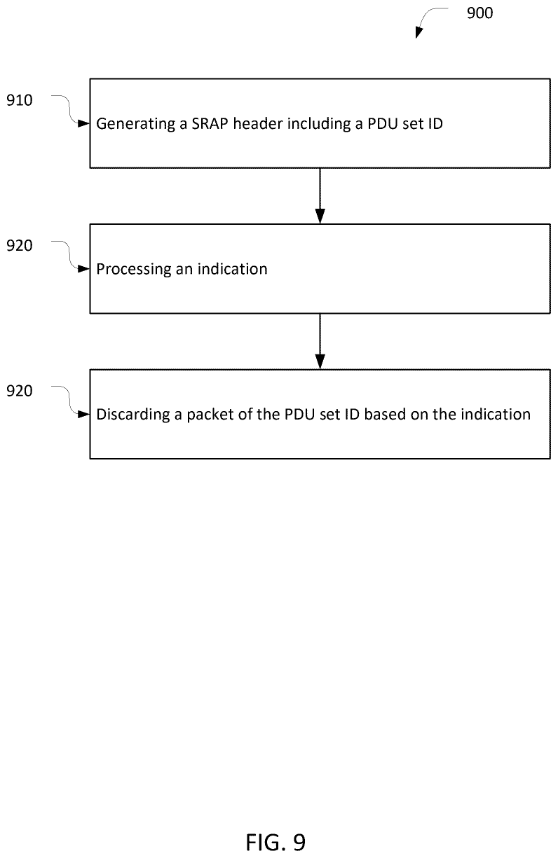

FIG. 9 illustrates an operation flow/algorithmic structure 900 (also referred to as operation 900) in accordance with some embodiments. The operation flow/algorithmic structure 900 may be performed or implemented by a UE such as, for example, the UE 104, 106, or UE 1200; or components thereof, for example, baseband processor circuitry 1204A. The operation flow/algorithmic structure 900 may be performed or implemented by a base station such as, for example, the BS 108 or the base station 1300; or components thereof, for example, baseband processor circuitry 1304A.

The operation flow/algorithmic structure 900 may include, at 910, generating an SRAP header, including a PDU set ID. Operation 900 may include generating a SRAP header to facilitate packet management in multi-hop relay scenarios. The SRAP header may enable the association of packets with their respective PDU sets at intermediate nodes, e.g., the relay UE 104, allowing all nodes within the relay chain to identify and process packets belonging to the same set. By including the PDU set ID, operation 900 may establish a mechanism for tracking and coordinating packets at lower protocol layers, such as RLC or MAC, which are agnostic to PDCP-layer information. The design of the SRAP header may also incorporate additional fields to support packet ordering, tracking, and discard operations.

In some embodiments, the SRAP header may include a sequence number of a protocol data convergence protocol (PDCP) service data unit (SDU) associated with the first packet, a UE ID, or a bearer ID. For example, the sequence number provides packet-level granularity for tracking and reordering operations, while the UE ID identifies the originating device, and the bearer ID associates the packet with a specific QoS flow. These fields enhance the header's functionality and ensure compatibility with multi-hop relay scenarios.

In some embodiments, a 6-bit field in the SRAP header may indicate the PDU set ID. This compact field design minimizes signaling overhead while providing sufficient granularity to identify PDU sets uniquely. The inclusion of the 6-bit PDU set ID ensures that intermediate nodes, such as relay UEs, can correlate packets to their respective PDU sets during relay operations.

In some embodiments, operation 900 may include processing a configuration including a threshold and determining that a number of transmission failures associated with the PDU set ID meets or exceeds the threshold. The number of transmission failures is determined based on lower-layer indications of how many retries are involved in the delivery of PDUs associated with the PDU set ID. For example, the configuration may specify a predefined limit for failed transmissions, allowing operation 900 to monitor lower-layer feedback mechanisms, such as ACK/NACK signaling or RLC status reports, to assess packet delivery success. If the number of failures exceeds the threshold, operation 900 may conclude that the PDU set is unlikely to be delivered successfully, enabling subsequent discard operations. In some embodiments, the number of transmission failures is based on counting the number of lower layer (e.g., PHY, MAC, or RLC) retransmissions of packets associated with the PDU set ID.

The operation flow/algorithmic structure 900 may include, at 920, processing an indication. Operation 900 may include processing an indication received from the relay UE 104, signaling a failure in the delivery of a first packet associated with the PDU set ID to a downstream node. This indication may enable operation 900 to assess the status of the affected PDU set and determine whether further transmission attempts are warranted. The relay UE may generate the indication based on its observations of failed delivery attempts, such as repeated NACK feedback or missing sequence numbers at the downstream node. Operation 900 may include evaluating the failure indication and correlating it with the PDU set ID to allow for informed packet management decisions.

In some embodiments, operation 900 may include generating a message for transmission to the relay UE 104 to indicate a failure to deliver a third packet associated with the PDU set ID. This operation may allow upstream nodes, e.g., the upstream node 505, to inform the relay UEs, e.g., the relay UE 104, about failures in delivering packets to subsequent nodes, enabling coordinated discard actions across the relay chain. The generated message may include fields such as the PDU set ID, sequence numbers, or flags indicating failure status, allowing for the relay UE 104 to manage the affected PDU set and associated PDUs or packets.

In some embodiments, operation 900 may include processing a message received from the relay UE 104, including the PDU set ID indicating a failure associated with the PDU set ID, and terminating generating or scheduling one or more packets associated with the PDU set ID for transmission to the downstream node, e.g., downstream node 605, based on processing the message. This operation may allow upstream nodes, e.g., the upstream node 505, to halt further packet generation or scheduling for failed PDU sets, conserving resources and avoiding unnecessary retransmissions. The received message may include details about the failure, such as latency constraints or transmission thresholds, enabling operation 900 to make informed decisions about terminating packet processing.

The operation flow/algorithmic structure 900 may include, at 930, discarding a packet of the PDU set ID based on the indication. Operation 900 includes discarding a second packet associated with the PDU set ID based on the indication received from the relay UE 104. After evaluating the failure indication, operation 900 may include determining that further transmission of packets within the PDU set is unlikely to succeed or contribute meaningfully to application-level data delivery. The discard operation may provide improved resource utilization by terminating transmission attempts for packets in failed PDU sets, thereby prioritizing other traffic flows and avoiding unnecessary retransmissions.

In some embodiments, the SRAP header may include a 1-bit flag to indicate the last packet associated with the PDU set ID. This flag signals the end of a PDU set, enabling operation 900 to identify the boundaries of the set and apply discard operations accordingly. The 1-bit flag may allow compatibility with sequential delivery scenarios, where intermediate nodes rely on explicit markers to determine completeness.

In some embodiments, the SRAP header may indicate a number of packets associated with the PDU set ID. By providing the total number of packets, operation 900 can track the completeness of the PDU set and apply discard operations when the count falls short of the expected total. This approach supports scenarios where sequential delivery is not guaranteed, ensuring robust management of PDU sets across relay nodes.

In some embodiments, the SRAP header may include a delay budget report associated with the PDU set ID. This report allows operation 900 to enforce latency constraints during packet processing, ensuring that packets exceeding the delay budget are discarded. The delay budget may be configured for transmission (Tx) or reception (Rx) operations, providing flexibility in managing PDU sets based on timing requirements.

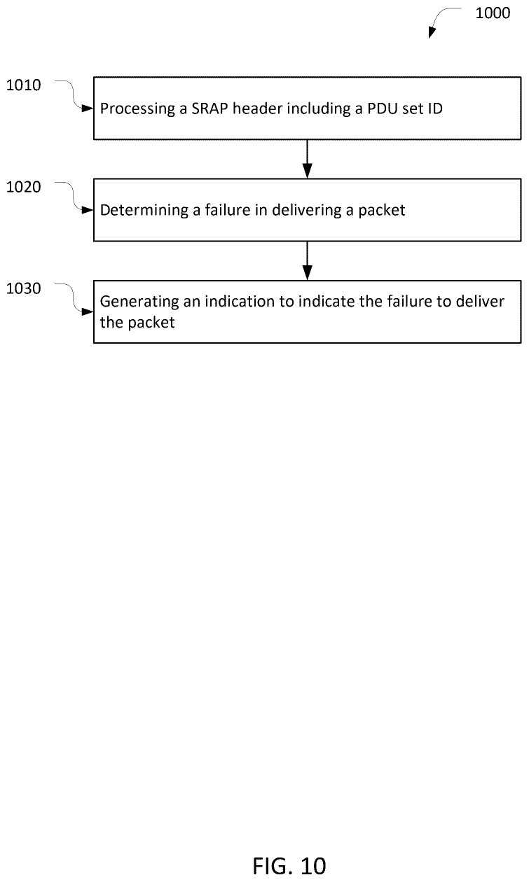

FIG. 10 illustrates another operation flow/algorithmic structure 1000 (also referred to as operation 1000) in accordance with some embodiments. The operation flow/algorithmic structure 1000 may be performed or implemented by a UE such as, for example, the UE 104, 106, or UE 1200; or components thereof, for example, baseband processor circuitry 1204A.

The operation flow/algorithmic structure 1000 may include, at 1010, processing an SRAP header, including a PDU set ID. Operation 1000 may include processing an SRAP header to facilitate packet management in multi-hop relay scenarios. The SRAP header may contain a PDU set ID that enables operation 1000 to associate packets with their respective PDU sets, allowing the relay UE 104 operations to track and coordinate packets effectively. Processing the SRAP header may allow operation 1000 to identify incoming packets and determine the appropriate actions for their handling, such as forwarding, tracking completeness, or discarding.

The operation flow/algorithmic structure 1000 may include, at 1020, determining a failure in delivering a packet. Operation 1000 may include determining a failure in delivering a packet associated with the PDU set ID to a downstream node. This determination may involve analyzing feedback mechanisms, such as ACK/NACK signaling, or detecting missing sequence numbers from the downstream node. By identifying delivery failures, operation 1000 ensures that packets associated with failed PDU sets are handled appropriately to optimize resource utilization.

In some embodiments, operation 1000 may include terminating forwarding to the downstream node 605 or discarding a second packet associated with the PDU set ID based on processing a message received from the upstream node 505 (e.g., the remote UE 106), including the PDU set ID. This operation may allow operation 1000 to respond to upstream notifications about failed deliveries by halting further processing of associated packets. The message may include details such as latency constraints, failure flags, or sequence numbers, enabling operation 1000 to make informed decisions about terminating packet forwarding or discarding.

In some embodiments, operation 1000 may detect an expiration of a timer, determine that a second packet associated with the PDU set ID is not delivered to the downstream node, and discard the second packet. For example, a Tx timer may be configured to enforce latency constraints for packets being delivered to the downstream node. If the timer expires before all packets in the PDU set are delivered, operation 1000 may discard the remaining packets in the buffer associated with the PDU set ID.

In some embodiments, operation 1000 may detect the expiration of a timer, determine that a second packet associated with the PDU set ID is not received from the upstream node, and discard a third packet associated with the PDU set ID. An Rx timer may be configured to enforce latency constraints for packets being received from the upstream node. If the timer expires before the relay node receives all packets in the PDU set, operation 1000 may discard packets associated with the PDU set ID that are destined for downstream nodes.

The operation flow/algorithmic structure 1000 may include, at 1030, generating an indication of the failure to deliver the packet. Operation 1000 may include generating an indication for transmission to the upstream node to signal a failure in delivering a packet associated with the PDU set ID to the downstream node 605. This indication may allow the upstream node 505 to be informed of delivery failures at later hops, enabling coordinated decisions about handling affected PDU sets. The generated indication may include the PDU set ID, flags indicating failure status, and other contextual information to facilitate efficient management of relay traffic.

In some embodiments, operation 1000 may include processing information received from the upstream node 505 and generating, based on the information, a DSR for transmission to the downstream node. For example, the upstream node 505 may provide details such as buffer size, delay bound, or remaining times associated with packets in transit. Operation 1000 may use this information to compile a DSR, allowing the downstream node 605 to prioritize resources for delay-critical traffic.

In some embodiments, the information provided by the upstream node 505 may include a buffer size, delay bound, or one or more remaining times associated with one or more packets. Operation 1000 uses these parameters to assess the urgency of delay-critical traffic and generate reports that facilitate proactive resource allocation by the downstream node.

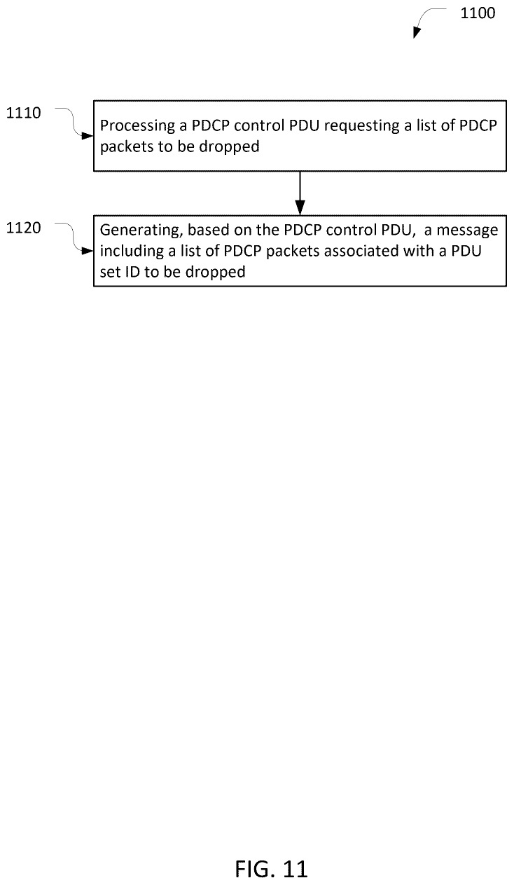

FIG. 11 illustrates another operation flow/algorithmic structure 1100 (also referred to as operation 1100) in accordance with some embodiments. The operation flow/algorithmic structure 1100 may be performed or implemented by a UE such as, for example, the UE 104, 106, or UE 1200; or components thereof, for example, baseband processor circuitry 1204A. The operation flow/algorithmic structure 1100 may be performed or implemented by a base station such as, for example, the BS 108 or the base station 1300; or components thereof, for example, baseband processor circuitry 1304A.

The operation flow/algorithmic structure 1100 may include, at 1110, processing PDCP control PDU requesting a list of PDCP packets to be dropped. Operation 1100 may include processing a PDCP control PDU received from a downstream node and forwarded by a relay UE. The PDCP control PDU may indicate a request for a list of PDCP packets associated with a specific PDU set ID to be dropped. This operation may enable the upstream node 505 to evaluate the request and determine the status of the affected packets. The PDCP control PDU may provide information, such as the PDU set ID and associated failure details, which may allow operation 1100 to identify the relevant packets.

The operation flow/algorithmic structure 1100 may include, at 1120, generating, based on the PDCP control PDU, a message including a list of PDCP packets associated with a PDU set ID to be dropped. Operation 1100 may include generating a message for transmission to the downstream node via the relay UE. This message may include a list of PDCP packets associated with the PDU set ID that are to be dropped based on the request processed at 1110.

In some embodiments, the list of PDCP packets to be dropped may include packet sequence numbers or ranges of sequence numbers within the PDU set. This granularity may allow operation 1100 to tailor the drop request to the specific packets that failed to meet latency or transmission requirements, ensuring that the downstream node can discard them without affecting other traffic.

In some embodiments, the generated message may include additional fields, such as flags indicating the failure status of the PDU set or contextual information about the network conditions that led to the drop request. These fields may enable the downstream node 605 to make informed decisions about subsequent processing or scheduling, contributing to efficient resource allocation and traffic management.

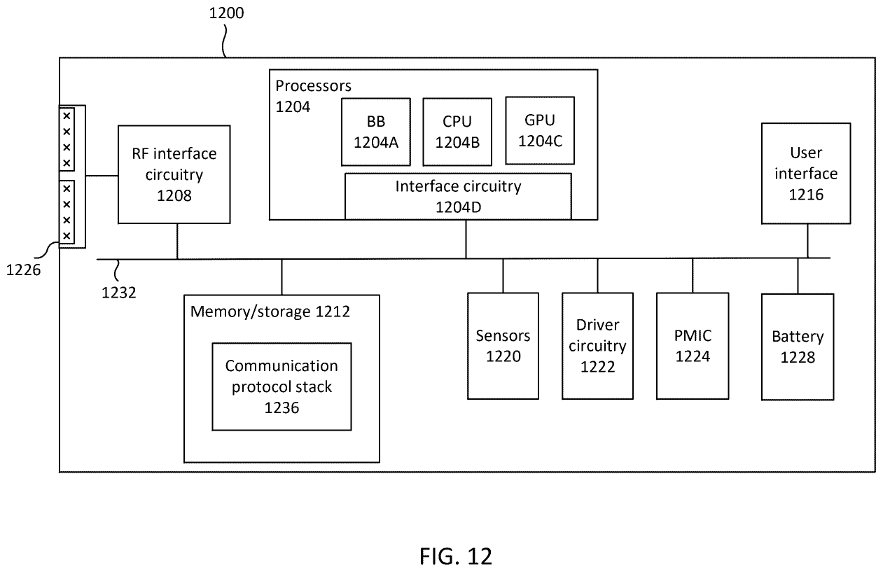

FIG. 12 illustrates a UE 1200 in accordance with some embodiments. The UE 1200 may be similar to and substantially interchangeable with the UE 104.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry, or processor circuitry that executes or otherwise operates computer-executable instructions, such as program code, software modules, or functional processes from memory/storage 1212 to cause the UE 1200 to perform operations as described herein. The processors 1204 may also include interface circuitry 1204D to communicatively couple the processor circuitry with one or more other components of the UE 1200. In some embodiments, at least one of processors 1204 may include RF interface circuitry 1208.

In some embodiments, the baseband processor circuitry 1204A may access a communication protocol stack 1236 in the memory/storage 1212 to communicate over a 3GPP-compatible network. In general, the baseband processor circuitry 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor circuitry 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within or connected to the UE 1200. For example, driver circuitry 1222 may include a display driver to control and allow access to a display device, a touchscreen driver to control and allow access to a touchscreen interface, sensor drivers to obtain sensor readings of sensors 1220, and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

A battery 1228 may power the UE 1200, although in some examples, the UE 1200 may be mounted deployed in a fixed location and may have a power supply coupled to an electrical grid. The battery 1228 may be a lithium-ion battery, a metal-air battery, such as a zinc-air battery, an aluminum-air battery, a lithium-air battery, and the like. In some implementations, such as in vehicle-based applications, the battery 1228 may be a typical lead-acid automotive battery.

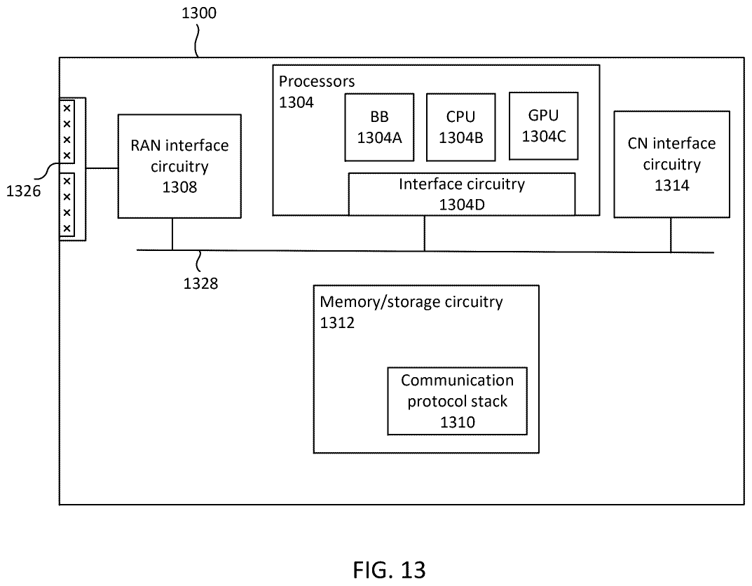

FIG. 13 illustrates a network device 1300 in accordance with some embodiments. The network device 1300 may be similar to and substantially interchangeable with base station 108.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the network device 1300 to perform operations as described herein. The processors 1304 may also include interface circuitry 1304D to communicatively couple the processor circuitry with one or more other components of the network device 1300. In some embodiments, at least one of processors 1304 may include RF interface circuitry 1308.

The CN interface circuitry 1314 may provide connectivity to a core network, for example, a 5th Generation Core network (5GC) using a 5GC-compatible network interface protocol such as carrier Ethernet protocols or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices generally recognized as meeting or exceeding industry or governmental requirements for maintaining users'privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method comprising: generating a first packet for transmission to a relay user equipment (UE), the first packet including a sidelink relay adaptation protocol (SRAP) header including a packet data unit (PDU) set identifier (ID); processing an indication, received from the relay UE, indicating a failure in delivery of the first packet to a downstream node; and discarding, based on the indication, a second packet associated with the PDU set ID.

Example 2 includes the method of example 1 or some other example herein, wherein the SRAP header includes: a sequence number of a protocol data convergence protocol (PDCP) service data unit (SDU) associated with the first packet; a UE ID; or a bearer ID.

Example 3 includes the method of example 1 or some other example herein, wherein a 6-bit field in SRAP header indicates the PDU set ID.

Example 4 includes the method of example 1 or some other examples herein, further including: generating a message for transmission to the relay UE, to indicate a failure to deliver a third packed associated with the PDU set ID.

Example 5 includes the method of example 1 or some other examples herein, further including: processing a message, received from the relay UE, including the PDU set ID indicating a failure associated with the PDU set ID; and terminating generating or scheduling one or more packets associated with the PDU set ID for transmission to the downstream node based on processing the message.

Example 6 includes the method of example 1 or some other examples herein, wherein the SRAP header includes a 1-bit flag to indicate a last packet associated with the PDU set ID.

Example 7 includes the method of example 1 or some other examples herein, wherein the SRAP header indicate a number of packets associated with the PDU set ID.

Example 8 includes the method of example 1 or some other examples herein, wherein the SRAP header includes a delay budget report associated with the PDU set ID.

Example 9 includes the method of example 1 or some other examples herein, further including: processing a configuration including a threshold; and determining that a number of transmission failures associated with the PDU set ID meets or exceeds the threshold, wherein said discarding a second packet associated with the PDU set ID is further based on said determining that the number of transmission failures associated with the PDU set ID meets or exceeds the threshold.

Example 10 include a method comprising: processing a sidelink relay adaptation protocol (SRAP) header including a packet data unit (PDU) set identifier (ID) of a packet received from an upstream node; determining a failure in delivering the packet to a downstream node; and generating an indication for transmission to the upstream node to indicate the failure to deliver the packet to the downstream node and the associated PDU set ID.

Example 11 includes the method of example 10 or some other examples herein, wherein the upstream node is a remote user equipment (UE) and the downstream node is a base station.

Example 12 includes the method of example 10 or some other examples herein, wherein the upstream node is a base station and the downstream node is a remote user equipment (UE).

Example 13 includes the method of example 10 or some other examples herein, wherein the SRAP header includes: a sequence number of a protocol data convergence protocol (PDCP) service data unit (SDU) associated with the packet; a UE ID; or a bearer ID.

Example 14 includes the method of example 10 or some other examples herein, wherein a 6-bit field in SRAP header indicates the PDU set ID.

Example 15 includes the method of example 10 or some other examples herein, wherein the packet is a first packet, and the method further includes: processing a message received from the upstream node, including the PDU set ID; and terminating forwarding to the downstream node or discarding, a second packet associated with the PDU set ID.

Example 16 includes the method of example 10 or some other examples herein, further including: processing a information received from the upstream node; and generating, based on the information, a delay status report for transmission to the downstream node.

Example 17 includes the method of example 10 or some other examples herein, wherein the packet is a first packet, and the method further includes: detecting an expiration of a timer; determining that a second packet associated with the PDU set ID is not delivered to the downstream node; and discarding the second packet.

Example 18 includes the method of example 10 or some other examples herein, wherein the packet is a first packet, and the method further includes: detecting an expiration of a timer; determining that a second packet associated with the PDU set ID is not received from the upstream node; and discarding a third packet associated with the PDU set ID.

Example 19 includes the method of example 16 or some other examples herein, wherein the information includes: a buffer size; delay bound; or one or more remaining times associated with one or more packets.

Example 20 includes a method comprising: processing a packet data convergence protocol (PDCP) control packet data unit (PDU) received from a downstream node via a relay user equipment (UE), the PDCP control PDU indicating a request for a list of PDCP packets to be dropped; and generating, based on the PDCP control PDU, a message for transmission to the downstream node via the relay UE, the message including the list of PDCP packets to be dropped, the PDCP packets associated with a PDU set identifier (ID).

Example 21 includes the method of example 20 or some other examples herein, wherein the PDCP control PDU includes the PDU set ID.

Example 22 includes the method of example 20 or some other examples herein, wherein the PDCP control PDU indicates a failure to transmit one or more packets associated with the PDU set ID.

Another example may include an apparatus comprising means to perform one or more elements of a method described in or related to any of examples 1-22, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Another example may include an apparatus comprising logic, modules, or circuitry to perform one or more elements of a method described in or related to any of examples 1-22, or any other method or process described herein.

Another example may include a method, technique, or process as described in or related to any of examples 1-22, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-22, or portions thereof.

Another example may include a signal as described in or related to any of examples 1-22, or portions or parts thereof.

Another example may include a datagram, information element, packet, frame, segment, PDU, or message as described in or related to any of examples 1-22, or portions or parts thereof, or otherwise described in the present disclosure.

Another example may include a signal encoded with data as described in or related to any of examples 1-22, or portions or parts thereof, or otherwise described in the present disclosure.

Another example may include a signal encoded with a datagram, IE, packet, frame, segment, PDU, or message as described in or related to any of examples 1-22, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Another example may include a computer program comprising instructions, wherein execution of the program by a processing element is to cause the processing element to carry out the method, techniques, or process as described in or related to any of examples 1-22, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
generating a first packet for transmission to a relay user equipment (UE), the first packet including a sidelink relay adaptation protocol (SRAP) header including a packet data unit (PDU) set identifier (ID);
processing an indication, received from the relay UE, indicating a failure in delivery of the first packet to a downstream node; and
discarding, based on the indication, a second packet associated with the PDU set ID.

2. The method of claim 1, wherein the SRAP header includes:
a sequence number of a protocol data convergence protocol (PDCP) service data unit (SDU) associated with the first packet;
a UE ID; or
a bearer ID.

3. The method of claim 1, wherein a 6-bit field in the SRAP header indicates the PDU set ID.

4. The method of claim 1, further comprising:
generating a message for transmission to the relay UE, to indicate a failure to deliver a third packet associated with the PDU set ID.

5. The method of claim 1, further comprising:
processing a message, received from the relay UE, including the PDU set ID to indicate a failure associated with the PDU set ID; and
terminating generating or scheduling at least one packet associated with the PDU set ID for transmission to the downstream node based on processing the message.

6. The method of claim 1, wherein the SRAP header includes:
a 1-bit flag to indicate a last packet associated with the PDU set ID; or a number of packets associated with the PDU set ID.

7. The method of claim 1, wherein the SRAP header includes a delay budget report associated with the PDU set ID.

8. The method of claim 1, further comprising:
processing a configuration including a threshold; and
determining that a number of transmission failures associated with the PDU set ID meets or exceeds the threshold, wherein said discarding a second packet associated with the PDU set ID is further based on said determining that the number of transmission failures associated with the PDU set ID meets or exceeds the threshold.

9. The method of claim 8, wherein the number of transmission failures associated with the PDU set ID is based on a number of lower layer retransmissions of packets associated with the PDU set ID.

10. An apparatus comprising:
processor circuitry to:
process a sidelink relay adaptation protocol (SRAP) header including a packet data unit (PDU) set identifier (ID) of a packet received from an upstream node;
determine a failure in delivering the packet to a downstream node; and
generate an indication for transmission to the upstream node to indicate the failure to deliver the packet to the downstream node and the associated PDU set ID; and
interface circuitry coupled to the processor circuitry to transmit the indication.

11. The apparatus of claim 10, wherein the upstream node is a remote user equipment (UE) and the downstream node is a base station, or wherein the upstream node is a base station and the downstream node is a remote UE.

12. The apparatus of claim 10, wherein the SRAP header includes:
a sequence number of a protocol data convergence protocol (PDCP) service data unit (SDU) associated with the packet;
a UE ID; or
a bearer ID.

13. The apparatus of claim 10, wherein a 6-bit field in SRAP header indicates the PDU set ID.

14. The apparatus of claim 10, wherein the packet is a first packet, and the processor circuitry is further to:
process a message received from the upstream node, the message including the PDU set ID; and
identify a second packet associated with the PDU set ID; and
terminate forwarding of the second packet to the downstream node or discard the second packet.

15. The apparatus of claim 10, wherein the processor circuitry is further to:
process information received from the upstream node, wherein the information includes a buffer size, a delay bound, or at least one remaining time associated with at least one packet; and
generate, based on the information, a delay status report for transmission to the downstream node.

16. The apparatus of claim 10, wherein the packet is a first packet, and the processor circuitry is further to:
detect an expiration of a timer;
determine that a second packet associated with the PDU set ID is not delivered to the downstream node; and
discard the second packet based on the expiration of the timer.

17. The apparatus of claim 10, wherein the packet is a first packet, and the processor circuitry is further to:
detect an expiration of a timer;
determine that a second packet associated with the PDU set ID is not received from the upstream node; and
discard a third packet associated with the PDU set ID based on the expiration of the timer.

18. A method comprising:
processing a packet data convergence protocol (PDCP) control packet data unit (PDU) received from a downstream node via a relay user equipment (UE), the PDCP control PDU indicating a request for a list of PDCP packets to be dropped; and
generating, based on the PDCP control PDU, a message for transmission to the downstream node via the relay UE, the message including the list of PDCP packets to be dropped, the PDCP packets associated with a PDU set identifier (ID).

19. The method of claim 18, wherein the PDCP control PDU includes the PDU set ID.

20. The method of claim 18, wherein the PDCP control PDU indicates a failure to transmit one or more packets associated with the PDU set ID.
